(19) United States
(12) Patent Application Publication
(10) Pub. No.: US 2013/0229338 A1
(43) Pub. Date: Sep. 5, 2013

(54) TEXTILE INTERFACE DEVICE AND METHOD FOR USE WITH HUMAN BODY-WORN BAND

(71) Applicant: ELECTRONICS AND TELECOMMUNICATIONS RESEARCH INSTITUTE, Daejeon City (KR)

(72) Inventors: Jong-Moo SOHN, Daejeon (KR); Kyoung-Ju NOH, Daejeon (KR); Yong-Ki SON, Daejeon (KR); Young-Sung KIM, Daejeon (KR)

(73) Assignee: ELECTRONICS AND TELECOMMUNICATIONS RESEARCH INSTITUTE, Daejeon City (KR)

(21) Appl. No.: 13/776,957

(22) Filed: Feb. 26, 2013

(30) Foreign Application Priority Data
Mar. 5, 2012 (KR) 10-2012-0022521

(51) Int. Cl. G06F 3/01

(52) U.S. Cl. CPC G06F 3/011
USPC 345/156

(57) ABSTRACT

Disclosed herein is a textile interface device and method for use with a human body-worn band. The textile interface device includes a detection unit provided in wearing means that is worn on a human body and configured to detect bio-signals from the human body, an interface unit disposed inside accommodation means provided on one side of the wearing means and configured to communicate with an electronic device accommodated in the accommodation means, and a plurality of textile buttons configured to generate control signals adapted to control the electronic device. The interface unit includes, on a textile, an optical reception unit configured to receive optical signals, an optical transmission unit configured to send the optical signals, and a light diffusion unit configured to diffuse light when the optical signals are sent. The interface unit communicates with the electronic device by means of light.

### CROSS REFERENCE TO RELATED APPLICATION

This application claims the benefit of Korean Patent Application No. 10-2012-0022521, filed on Mar. 5, 2012, which is hereby incorporated by reference in its entirety into this application.

### BACKGROUND OF THE INVENTION

1. Technical Field

The present invention relates generally to a textile interface device and method for use with a human body-worn band and, more particularly, to a textile interface device and method for use with a human body-worn band, which are capable of implementing the interface between a textile-based aim band, which communicates by means of light, and a portable electronic device.

2. Description of the Related Art

Methods of recording and observing chronic diseases, such as diabetes or cardiovascular disorders, have developed so that they can be more easily utilized by users, thanks to the persistent development of medical and electronic technology. These methods have been utilized not only by doctors in a professional manner but also by common individuals as simple personal health management methods.

For this purpose, a variety of types of conventional health management systems record a variety of types of status during the wearers' daily lives or exercise and use the recorded information as basic data to make a later determination about the wearers' health status. These health management measurement systems have been modified into a variety of forms, such as into watches or clothing. Recently, smaller-sized watches and arm band-shaped measurement systems have appeared.

However, most of these measurement systems merely record measured information first and then later check the measured results with the assistance of experts or automated analysis software, so that wearers cannot check the measured results in real time. As an example, Bodymedia's Sensewear, which is a representative commercial product, is shaped in the form of a band that is worn around the aim, and presents a method of transferring measured data to a server in a wired manner and analyzing the measured data. This method has the advantage of enabling accurate diagnosis with the assistance of professional software present on a server, but has the disadvantage of a wearer being unable to check his or her status almost in real time. U.S. Unexamined Patent Application Publication No. 20060031102 entitled “System for detecting, monitoring, and reporting an individual's physiological or contextual status,” which is one of the patents and patent applications of the company, discloses a system that measures and reports a wearer's physiological or contextual status However, this technology does not propose a method by which a wearer can check information in real time, and presents only a general description with respect to a method of transferring the data of an actual sensor device to an external device (a computer, a portable terminal, or the like). That is, it mentions a physically wired connection method and a wireless method requiring a burdensome connection procedure with a possibility of interference.

As a result, in order to maximize the convenience of a wearer's real-time use, an easy connection method must be provided, and a detection device, a data processing device and a user interface device must be integrated with one another. Furthermore, for the sake of a wearer's convenience when wearing it, the device must be flexible, and a new wearer interface method must be provided for the flexible device.

### SUMMARY OF THE INVENTION

Accordingly, the present invention has been made keeping in mind the above problems occurring in the prior art, and an object of the present invention is to provide a textile interface device and method for use with a human body-worn band, in which the principal circuits of the human body-worn band and a wearer interface are configured based on a textile, and thus frequency interference and security problems can be avoided.

Another object of the present invention is to provide a textile interface device and method for use with a human body-worn band, in which the principal circuits of the human body-worn band and a wearer interface are implemented on a flexible textile, and thus the sensation of wearing and the convenience of use can be improved.

Still another object of the present invention is to provide a textile interface device and method for use with a human body-worn band, in which a wearer's portable electronic device is accommodated in the human body-worn band and the wearer's portable electronic device and the human body-worn band communicate with each other, and thus real-time accessibility to measured information and the utilization of the measured information can be improved.

In order to accomplish the above object, the present invention provides a textile interface device for use with a human body-worn band, including a detection unit provided in wearing means that is worn on a human body, and configured to detect bio-signals from the human body; an interface unit disposed inside accommodation means provided on one side of the wearing means, and configured to communicate with an electronic device accommodated in the accommodation means; and a plurality of textile buttons configured to generate control signals adapted to control the electronic device; wherein the interface unit comprises, on a textile, an optical reception unit configured to receive optical signals, an optical transmission unit configured to send the optical signals, and a light diffusion unit configured to diffuse light when the optical signals are sent, and the interface unit communicates with the electronic device by means of light; and wherein each of the textile buttons comprises a textile, an electrode provided on the textile in a button shape, and a ground configured to surround the electrode, a surplus portion of the ground being bent so that the surplus portion is disposed over a rear surface of the electrode.

The detection unit may include a plurality of electrodes or sensors that are configured to measure bio-signals from a wearer who is wearing the wearing means.

The detection unit may further include a preprocessing unit that digitizes the bio-signals that are detected by the electrodes or sensors.

The preprocessing unit may include a filter configured to remove noise from the detected bio-signals; an amplifier configured to amplify the bio-signals from which the noise has been removed; and a converter configured to digitize the amplified bio-signals.

The optical reception unit may include an amplifier circuit that includes any one of a photodiode and an infrared sensor.

The light diffusion unit may include any one of a light-emitting plastic optical fiber and an EL (Electroluminescence) wire, and may be formed in the shape of a surface.

The textile interface device may further include a microcontroller unit disposed between the detection unit and the interface unit, and configured to perform post processing on signals provided from the detection unit, and control transmission and reception of data to and from the electronic device via the interface unit.

The electronic device may include application software that records and analyzes data about the optical signals received from the interface unit.

The electronic device may include an optical transmission and reception connector connected to an external extension port of the electronic device to perform optical communication with the interface unit; and the optical transmission and reception connector may include a connection port connected to the external extension port of the electronic device; a transmission unit configured to send the optical signals transferred from the electronic device; a reception unit configured to receive the optical signals from the interface unit; and a control unit configured to convert the optical signals sent and received between the electronic device and the interface unit, and to perform buffering in order to convert the optical signals.

The wearing means may further include an external interface unit that connects with an external debugger and performs charging.

The accommodation means may include an accommodation space configured to accommodate the electronic device in an inner space thereof; and an opening formed in a region of the accommodation means corresponding to the screen of the accommodated electronic device so that the screen of the accommodated electronic device can be exposed to an outside.

In order to accomplish the above object, the present invention provides a textile interface method for use with a human body-worn band, including detecting a wearer's bio-signals using a detection unit provided in wearing means; receiving the bio-signals and control signals generated by textile buttons via a textile-formed interface unit inside accommodation means provided on one side of the wearing means; and performing optical communication with an electronic device accommodated in the accommodation means via the interface unit; wherein the performing optical communication include, once the electronic device has been inserted into the accommodation space, completing a connection for the optical communication via the interface unit; sending the bio-signals and the control signals generated by the textile buttons to the electronic device via the interface unit; recording and analyzing data about the bio-signals using application software of the electronic device; and controlling the electronic device based on the control signals generated by the textile buttons using the application software of the electronic device.

The receiving the bio-signals and control signals generated by textile buttons may include removing noise from the bio-signals, amplifying the bio-signals from which the noise has been removed, and digitizing the amplified bio-signals using a preprocessing unit of the detection unit.

The performing optical communication may include performing, by the electronic device, optical communication with the interface unit via an optical transmission and reception connector connected to an external extension port.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing the appearance of a textile interface device for use with a human body-worn band according to an embodiment of the present invention;

FIG. 2 is a perspective view showing the appearance of a textile interface device for use with a human body-worn band according to another embodiment of the present invention;

FIG. 3 is a diagram showing the configuration of the textile interface device for use with a human body-worn band according to the present invention;

FIG. 4 is a diagram showing the detailed configuration of the textile interface device for use with a human body-worn band according to the present invention;

FIGS. 5 to 7 are diagrams showing the structure of a textile button that has been adopted by the textile interface device for use with a human body-worn band according to the present invention;

FIG. 8 is a diagram showing the configuration of an optical transmission and reception connector that has been adopted by the textile interface device in a human body-worn band according to the present invention.

FIG. 9 is a flowchart showing a textile interface method for use with a human body-worn band according to an embodiment of the present invention; and

FIG. 10 is a flowchart showing a method of optical communication in the textile interface method for use with a human body-worn band according to an embodiment of the present invention.

### DESCRIPTION OF THE PREFERRED EMBODIMENTS

The embodiments of the present invention will be given with reference to the accompanying drawings in order to fully describe the present invention so that persons having ordinary skill in the art can easily practice the technical spirit of the present invention. It should be noted that similar reference symbols are used to designate similar elements throughout the drawings even when the elements are depicted in different drawings. Furthermore, in the following description of the present invention, detailed descriptions of one or more related well-known constructions and/or one or more functions which have been deemed to make the gist of the present invention unnecessarily vague will be omitted.

Textile interface devices for use with a human body-worn band according to embodiments of the present invention will be described in detail below with reference to the accompanying drawings.

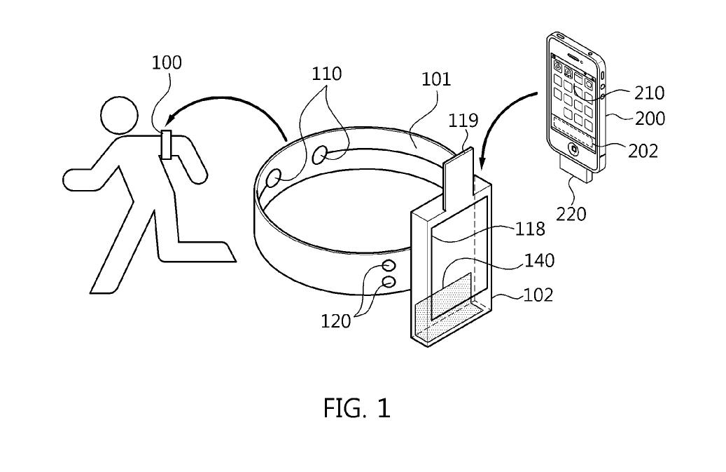

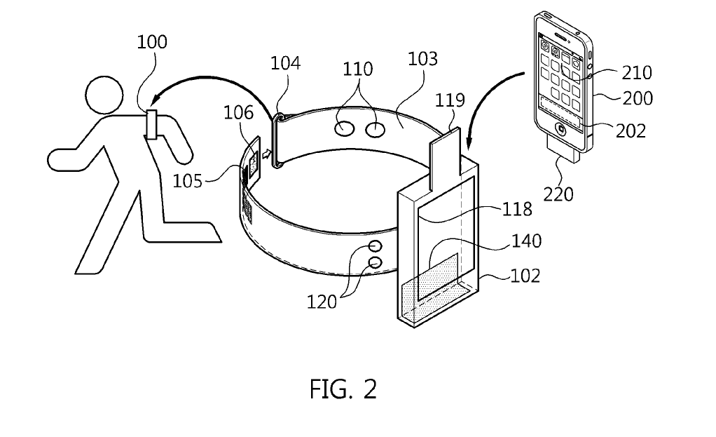

FIG. 1 is a perspective view showing the appearance of the textile interface device for use with a human body-worn band according to an embodiment of the present invention, and FIG. 2 is a perspective view showing the appearance of the textile interface device for use with a human body-worn band according to another embodiment of the present invention.

Referring to FIG. 1, a human body-worn band 100 according to the present invention includes a wearing means 101 configured to be worn around a human body, and accommodation means 102 provided on one side of the wearing means 101. The wearing means 101 is implemented in the form of a band that is made of flexible textile so that the wearer will find it convenient to wear it. One or more detection units 110, including sensors 111 or electrodes, which are configured to measure the bio-signals of a wearer, are located on the surface of the wearing means 101 that comes into contact with the skin. In this case, when the method used to take measurements is a non-contact measuring method or when only a wearer's motion is measured using a 3-axis acceleration sensor 111, the sensors 111 or electrodes may be contained therein. The accommodation means 102 that can accommodate an electronic device 200 is provided on one side of the wearing means 101. The accommodation means 102 includes an accommodation space configured to accommodate the electronic device 200 therein, and an opening 118 formed in an area corresponding to the screen 210 to allow the screen 210 of the accommodated electronic device 200 to be exposed to the outside.

Fastening means 119 that prevents the inserted electronic device 200 from being removed and taken out may be provided on the top of the accommodation means 102. Although in this case, the fastening means 119 may be fastened to the rear surface of the accommodation means 102 using Velcro or button-type securing means, the securing means may not be required depending on the material or shape of the accommodation means 102. A light diffusion unit 143 that is used for the transmission and reception of the optical data of the wearing means 101 and the electronic device 200 is disposed in the accommodation means 102. The light diffusion unit 143 may be implemented in a variety of ways depending on the method of implementation and the material and shape of the accommodation means 102. For example, the accommodation means 102 into which the light diffusion unit 143 has been incorporated may be implemented by weaving optical fiber into part of the inside of the accommodation means 102 made of textile. As another example, the wearing means 101 may be implemented by implementing all circuits performing the functionality of the wearing means 101 directly on a textile and putting the textile into a separate covering in which the light diffusion unit has been encapsulated. When a thin diffusive film is used as the light diffusion unit 143, the flexibility of the material of the accommodation means 102 can be maintained by attaching a diffusive film to the inside of the accommodation means 102.

The wearing means 101 is provided with one or more textile buttons 120 to control the multimedia playback functionality of the electronic device 200, and detects a wearer's touch.

Furthermore, an optical transmission connector 220 that transmits and receives light signals is connected to an external extension port of the electronic device 200 that is accommodated in the accommodation means 102. In this case, the electronic device 200 may be one of a variety of entertainment mobile devices such as a mobile phone, a Moving Picture Experts Group layer-3 (MP3) player, and a Portable Multimedia Player (PMP). Furthermore, application software 202 that records or analyzes data received from the wearing means 101 is installed on the electronic device 200. In this case, the application software 202 provides the functions of managing a wearer, setting the wearing means 101, and recording and analyzing the data received from the wearing means 101 using a separate Graphic User Interface (GUI).

Meanwhile, as shown in FIG. 2, the human body-worn band according to the present invention may be configured in the form of a strip, other than the above-described band. A ring 104 is provided on one side of the strip 103 forming the wearing means 101, and a Velcro loop 105 and a Velcro hook 106 are provided on the other side thereof. The length of the strip may be adjusted by passing the other end on which the Velcro hook 106 has been disposed through the ring 104, and thus the diameter of the wearing means 101 is freely adjusted to fit the thickness of the arm of the wearer.

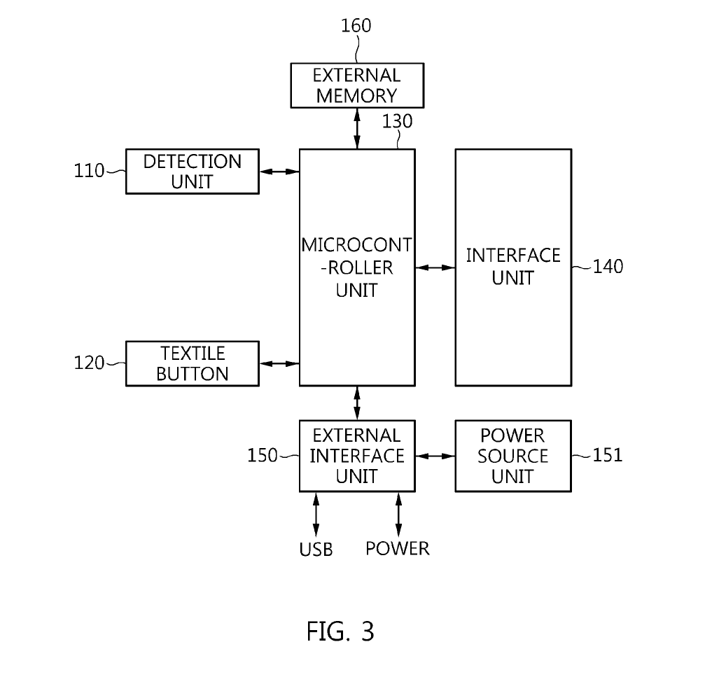

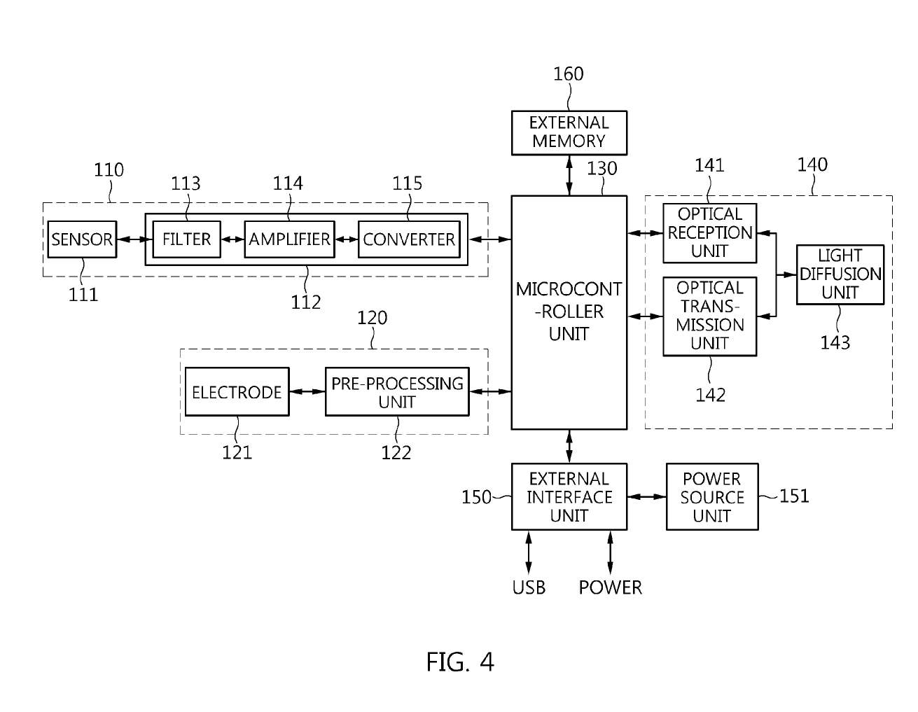

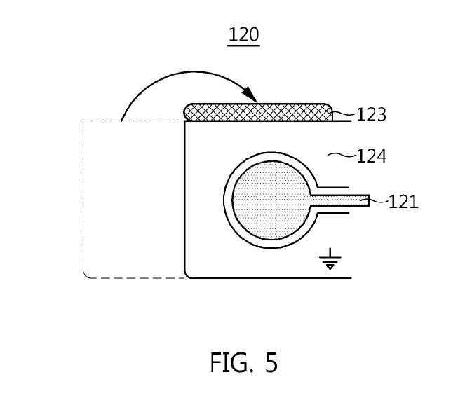

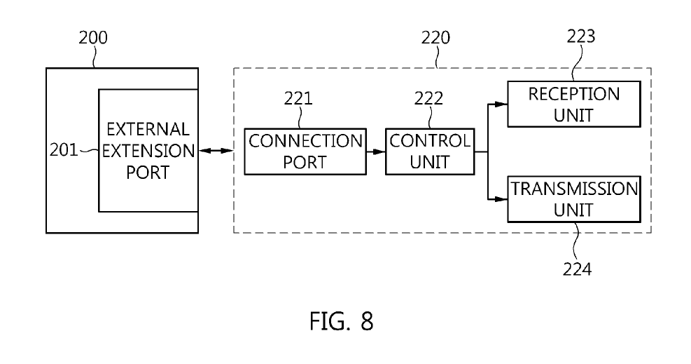

FIG. 3 is a diagram showing the configuration of the textile interface device for use with a human body-worn band according to the present invention, FIG. 4 is a diagram showing the detailed configuration of the textile interface device for use with a human body-worn band according to the present invention, FIGS. 5 to 7 are diagrams showing the structure of a textile button that has been adopted by the textile interface device for use with a human body-worn band according to the present invention, and FIG. 8 is a diagram showing the configuration of an optical transmission and reception connector that has been adopted by the textile interface device in a human body-worn band according to the present invention.

Referring to FIGS. 3 to 4, the textile interface device for use with a human body-worn band according to the present invention includes a detection unit 110, a textile button 120, a microcontroller unit 130, an interface unit 140 including an optical reception unit 141, an optical transmission unit 142, and a light diffusion unit 143, an external interface unit 150, and an external memory 160.

The detection unit 110 is provided in the wearing means 101 to be worn on a human body, and detects bio-signals from the human body. In this case, the detection unit 110 may include a plurality of electrodes or sensors 111 to measure the bio-signals of a wearer who is wearing the wearing means 101. As an example, the detection unit 110 measures physical motion using a single 3D acceleration sensor 111 in order to measure the amount of the wearer's movement, and may additionally detects bio-signal information and use the information to compute the amount of movement. Furthermore, the detection unit 110 may measure an electrocardiogram or skin resistance using the electrodes, and blood flow rate or body temperature using the sensors 111. Furthermore, when the detection unit 110 uses the sensors 111 rather than the electrodes, the electrodes do not need to be located outside the wearing means 101.

The detection unit 110 includes the electrodes or sensors 111 configured to measure physical signals and a preprocessing unit 112 configured to convert the output signals by processing them. In this case, the preprocessing unit 112 quantizes the analog signals into digital signal values and then transfers the digital signals to a microcontroller unit. In greater detail, the preprocessing unit 112 includes a filter 113 configured to remove noise from the bio-signals detected by the electrodes or sensors 111, an amplifier 114 configured to amplify the bio-signals, and a converter 115 configured to convert the amplified bio-signals into digital signals. The preprocessing unit 112 generates the digital signals that can be received and processed by the microcontroller unit. Meanwhile, if the output signals of the detection unit 110 are digital signal values that have already been quantized, the preprocessing unit 112 may be omitted.

The textile buttons 120 are provided on the wearing means 101, and generate control signals that are used to control the electronic device 200 accommodated in the accommodation means 102. The textile buttons 120 corresponding to the wearer interface are implemented on the textile, as shown in FIG. 5.

The textile buttons 120 are configured in such a form that a series of circuits each including an electrode and a preprocessing unit are connected to the microcontroller unit 130. For example, each of the touch buttons 120 is configured using the electrode 121 that is configured such that the wearer touches it and the preprocessing unit 122 that is configured such that the circuit thereof is formed of a circuit or a dedicated controller capable of detecting variations in the capacitance of the corresponding electrode. That is, the preprocessing unit 122 detects a variation in the capacitance when the wearer touches the electrode 121, and generates and transfers a signal so that the microcontroller unit 130 can recognize the variation Meanwhile, the textile buttons 120 include at least three touch buttons 120. When the microcontroller unit 130 is programmed to recognize double touch and sliding up and down operations, the double touch operation may correspond to a playback or temporary stop command, the sliding up operation to a volume up command, and the sliding down operation to a volume down command.

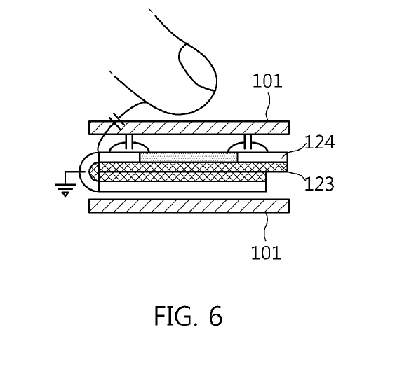

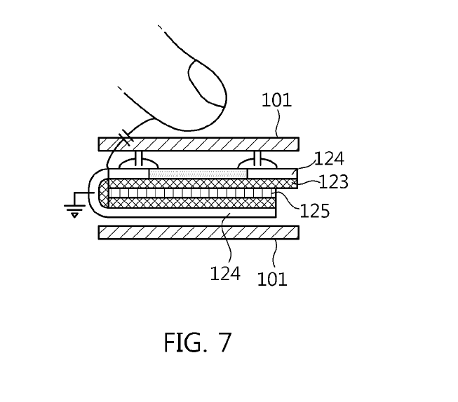

Furthermore, each of the textile buttons 120 includes a textile 123 configured such that it can be put on the textile, the button-shaped electrode 121 provided on the textile 123, and a ground 124 configured to surround the electrode 121 and restrict an electric field. In this case, in order to overcome the problem of the total touch recognition rate decreasing because the variation in capacitance attributable to the approach of a finger and a touch and a variation in capacitance attributable to the approach of the wearer's arm affects the total variation in capacitance, the textile button 120 is configured such that the electrode 121 and the ground 124 surrounding the electrode 121 are provided on the textile and the surplus portion of the ground is bent over and attached to the rear surface of the electrode 121, as shown in FIG. 5, thereby restricting an electric field that is formed near the rear surface of the electrode 121. Here, when a variation occurs in the interval between the surplus portion of the ground 124 bent over the rear surface and the electrode 121, the capacitance Cg between the electrode 121 and the ground 124 varies and thus erroneous detection may be performed. Accordingly, the surplus portion of the ground 124 bent over the rear surface and the textile are put into close attachment with each other. When the electrode and the ground configured as illustrated in FIG. 5 are provided on the textile, inserted into the wearing means 101 and then worn around a wearer's arm, the section thereof is the same as shown in FIG. 6. In this state, an electric field formed below the electrode 121 is blocked by the portion of the ground 124 disposed immediately below and bent over the rear surface of the electrode 121, thereby improving the touch effect of the button 120. Meanwhile, in some cases, as shown in FIG. 7, the interval between the electrode 121 and the portion of the ground 124 bent over the rear surface is fixed using an adhesive 125 applied to a specific thickness, and a basic capacitance value formed in the electrode 121 may be adjusted by controlling the thickness of the adhesive 125.

The microcontroller unit 130 is interposed between the detection unit 110 and the interface unit 140, and performs control so that post processing is performed on a signal provided by the detection unit 110 or textile button 120 and the results of the post processing are sent to the electronic device 200 via the interface unit 140. The microcontroller unit 130 may apply new settings based on the modification of software depending on post processing performance, power requirements, and the functional requirements of the wearing means 101. For example, the microcontroller unit 130 may perform control so that a signal provided by the detection unit 110 is sent to the electronic device 200 via the interface unit 140 and an overall algorithm for computing the amount of movement is executed in the electronic device 200, or so that meaningful intermediate information is obtained by analyzing a signal provided by the detection unit 110 and the corresponding information is sent to the electronic device 200 via the interface unit 140. Alternatively, the microcontroller unit 130 may fully analyze a signal provided by the detection unit 110, and send only information to be displayed on the screen 210 of the electronic device 200 via the interface unit 140. Furthermore, the microcontroller unit 130 may be provided with separate external memory 160, and may send a value provided by the detection unit 110 or intermediate information obtained by analysis to the electronic device 200 via the interface unit 140 and also store it in the external memory 160. However, if the microcontroller has a sufficient memory space, separate external memory 160 may not be provided.

The interface unit 140 is disposed inside the accommodation means 102 provided on one side of the wearing means 101, and communicates with the electronic device 200 accommodated in the accommodation means 102.

For this purpose, the interface unit 140 includes an optical reception unit 141, an optical transmission unit 142, and a light diffusion unit 143.

The optical reception unit 141 is formed of an amplifier circuit including any one of a photodiode and an infrared sensor in order to receive optical signals.

The optical transmission unit 142 is formed of a drive circuit including an infrared LED and a laser in order to send optical signals. In this case, the optical transmission unit 142 sends an optical signal at the minimum intensity so that only the optical transmission and reception connector 220 of the electronic device 200 accommodated in the accommodation means 102 can detect the optical signal.

The optical reception unit 141 and the optical transmission unit 142 are connected to a single light diffusion unit 143. The light diffusion unit 143 includes any one of a light-emitting plastic optical fiber and an EL (Electroluminescence) wire and is also spread over the textile in the form of a surface in order to diffuse light when sending an optical signal, so that the electronic device 200 can more effectively receive optical signals. In this case, the optical reception unit 141 and the optical transmission unit 142 share a single light diffusion unit 143, and transmission and reception cannot be performed at the same time. Accordingly, the time at which the optical reception unit 141 receives an optical signal and the time at which the optical transmission unit 142 sends an optical signal are controlled by the microcontroller unit 130, and one of a variety of methods, such as TDM, CSMA/CD and CSMA/CA, may be used in order to share the medium.

The wearing means 101 further includes an external interface unit 150 and a power source unit 151. The external interface unit 150 may perform the debugging of the microcontroller unit 130, the programming of software, and the data transmission of the external memory 160 by providing an external connection such as a USB connection, and the charging of the internal battery of the wearing means 101 may be performed by providing USB power to the power source unit 151.

The optical transmission and reception connector 220 is connected to the external extension port 201 of the electronic device 200 so as to support optical communication between the electronic device 200 and the interface unit 140. As shown in FIG. 8, the optical transmission and reception connector 220 includes a connection port 221 connected to the external extension port 201 of the electronic device 200, the transmission unit 224 configured to send a signal sent from an electronic device 200 in the form of an optical signal, a reception unit 223 configured to receive an optical signal from the interface unit 140, and a control unit 222 configured to transfer and control signals sent and received between the electronic device 200 and the interface unit 140.

The optical transmission and reception connector 220 operates using power supplied by the electronic device 200, or using its own power if power is not supplied. The optical transmission and reception connector 220 may communicate using the intrinsic protocol of the electronic device 200 or any standard serial communication protocol such as the UART and USB protocol.

The reception unit 223 and transmission unit 224 of the optical transmission and reception connector 220 send and receive optical signals in the same way as the optical reception unit 141 and optical transmission unit 142 of the wearing means 101. As described above, although the reception unit 223 and transmission unit 224 of the optical transmission and reception connector 220 may be configured in the same form as the optical reception unit 141 and optical transmission unit 142 of the wearing means 101, the common light diffusion unit is not used.

The control unit 222 of the optical transmission and reception connector 220 sends data sent from the electronic device 200 via the transmission unit 224, and transfers data received via the reception unit 223 to the electronic device 200.

The connection between the optical transmission and reception connector 220 and the electronic device 200 will be described as being the connection between a master and a slave in detail below.

For example, the wearing means 101 is implemented as a master, and the electronic device 200 is implemented as a slave. Although they may be implemented in the opposite manner, the following description will be based on the assumption that they are implemented in the former manner. When the master and the slave start to operate, the master waits for a response message, and periodically sends a discovery message regardless of the reception of the response message. Here, the discovery message includes at least type information which is used to distinguish the message and the time at which a subsequent discovery message will be sent. The discovery message may further include the product information of the master device and the version information of software. Furthermore, the cycle of the transmission of a message may be dynamically changed by the master after pre- and post-connection establishment, transmission errors and a connection sustaining period have been taken into consideration. If the master receives a discovery response message to a discovery message sent by it from the slave, the master determines that a connection with the slave has been established; otherwise, the master determines that a connection with the slave has been released. The master may determine connection or release using the number of discovery response messages that have been periodically and successively received. Additionally, the master may forcibly release a connection in compliance with a wearer's intention that is transferred via external software or a wearer interface. If the slave receives a discovery message, it generates a discovery response message, sends it to the master, and determines that a connection with the master has been established. In this case, if at least one discovery message has been additionally received in the period up to the time at which a subsequent discovery message is sent, which is included in the received discovery message, the connection with the master is maintained; if an additional discovery message has not been received in the period up to the specific time, the connection with the master is released. The discovery response message includes at least type information used to distinguish the message, and may additionally include the product information of the slave device and the version information of software. The slave may determine connection or release using the number of discovery messages that have periodically and successively been received.

A textile interface method for use with a human body-worn band according to an embodiment of the present invention will be described in detail with reference to the accompanying drawings.

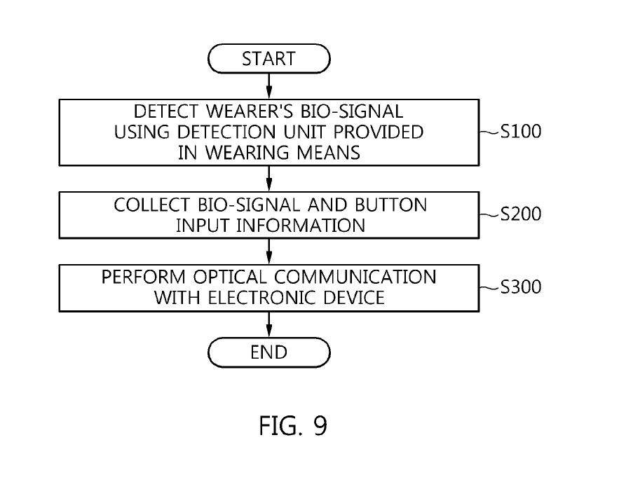

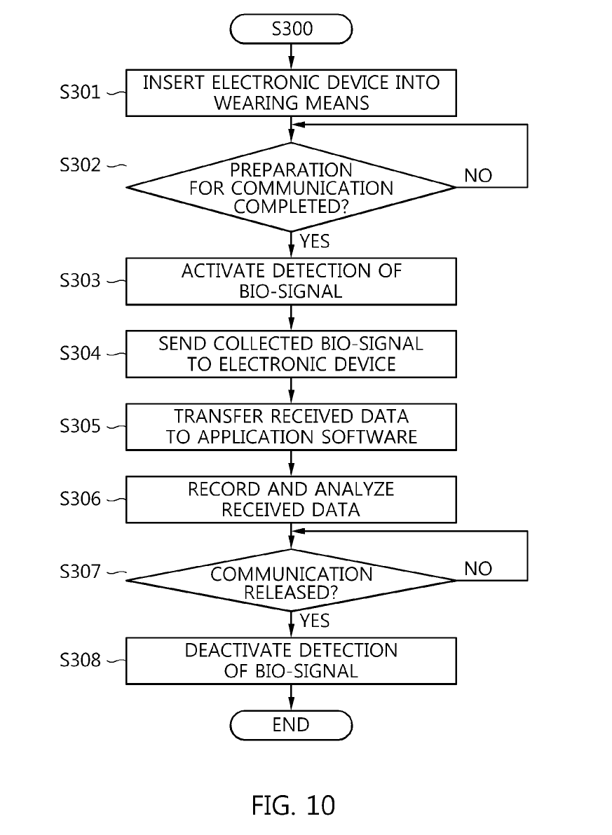

FIG. 9 is a flowchart showing the flow of a textile interface method for use with a human body-worn band according to the present invention, and FIG. 10 is a flowchart showing a method of performing optical communication in the textile interface method for use with a human body-worn band according to the present invention.

As shown in FIGS. 9 and 10, the present invention is configured to detect a wearer's bio-signal using the detection unit 110 provided in the wearing means 101 worn on the human body at step S100. Here, the detection unit 110 may include a plurality of electrodes or sensors 111 that are used to measure bio-signals from a wearer who wears the wearing means 101.

Thereafter, the microcontroller unit that is included in the wearing means 101 receives the bio-signals and button input information at step S200. Here, the preprocessing unit 112 of the detection unit 110 performs filtering, amplification and digital conversion on the bio-signals.

Thereafter, optical communication with the electronic device 200 accommodated in the accommodation means 102 is performed via the interface unit 140 at step S300.

In greater detail, when the electronic device 200 on which the application software 202 is running is accommodated in the accommodation means 102 of the wearing means 101 that is being powered, the wearing means 101 and the electronic device 200 are connected to each other at step S301. When the connection of the wearing means 101 is recognized at step S301, the wearing means 101 automatically activates the detection unit 110 and its function of detecting signals at step S303 and the detected signals are sent to the electronic device 200 at step S304. In this case, the signals to be sent are periodically sent at detection intervals, or are collected and then sent at one time. The optical signals transmitted via the interface unit 140 of the wearing means 101 are transferred to the application software 202 of the electronic device 200 via the optical transmission and reception connector 220 connected to the external extension port of the electronic device 200 at step S305. In this case, an additional operation may be performed to convert the type of optical signals received by the control unit 222 provided in the optical transmission and reception connector 220 into the type of signals that can be recognized by the electronic device 200 and the application software 202. Furthermore, the application software 202 converts the type of received signals into the type of signals that can be recognized by the wearer and then displays them. If desired, the application software 202 may additionally perform the recording, analyzing and processing of data using basic functions (time, a location, an altitude, etc.) that are fundamentally provided by the electronic device 200 at step S306. Thereafter, if the connection is maintained, the process of displaying the information detected by the wearing means 101 on the electronic device 200 in real time is repeated. However, if the interconnection is released at step S307 because the electronic device 200 is separated from the accommodation means 102, the power of any one of them is turned off, or the running of the application software 202 is stopped, the wearing means 101 automatically deactivates the detection unit 110 and its function of processing signals at step S308, thereby minimizing power consumption.

The textile interface device and method for use with a human body-worn band according to the present invention has the advantage of avoiding frequency interference and security problems because the principal circuits of the human body-worn band and a wearer interface are configured based on a textile, thereby improving the performance of communication.

Furthermore, the textile interface device and method for use with a human body-worn band according to the present invention has the advantage of improving the sensation of wearing and the convenience of use because the principal circuits of the human body-worn band and a wearer interface are implemented on a flexible textile.

Moreover, the textile interface device and method for use with a human body-worn band according to the present invention has the advantage of and improving real-time accessibility to measured information and the utilization of the measured information because a wearer's portable electronic device is accommodated in the human body-worn band and the wearer's portable electronic device and the human body-worn band communicate with each other.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A textile interface device for use with a human body-worn band, comprising:
a detection unit provided in wearing means that is worn on a human body, and configured to detect bio-signals from the human body;
an interface unit disposed inside accommodation means provided on one side of the wearing means, and configured to communicate with an electronic device accommodated in the accommodation means; and
a plurality of textile buttons configured to generate control signals adapted to control the electronic device;
wherein the interface unit comprises, on a textile, an optical reception unit configured to receive optical signals, an optical transmission unit configured to send the optical signals, and a light diffusion unit configured to diffuse light when the optical signals are sent, and the interface unit communicates with the electronic device by means of light; and
wherein each of the textile buttons comprises a textile, an electrode provided on the textile in a button shape, and a ground configured to surround the electrode, a surplus portion of the ground being bent so that the surplus portion is disposed over a rear surface of the electrode.

2. The textile interface device of claim 1, wherein the detection unit comprises a plurality of electrodes or sensors that are configured to measure bio-signals from a wearer who is wearing the wearing means.

3. The textile interface device of claim 2, wherein the detection unit further comprises a preprocessing unit that digitizes the bio-signals that are detected by the electrodes or sensors.

4. The textile interface device of claim 3, wherein the preprocessing unit comprises:
a filter configured to remove noise from the detected bio-signals;
an amplifier configured to amplify the bio-signals from which the noise has been removed; and
a converter configured to digitize the amplified bio-signals.

5. The textile interface device of claim 1, wherein the optical reception unit comprises an amplifier circuit that includes any one of a photodiode and an infrared sensor.

6. The textile interface device of claim 1, wherein the light diffusion unit comprises any one of a light-emitting plastic optical fiber and an EL (Electroluminescence) wire, and is formed in a surface shape.

7. The textile interface device of claim 1, further comprising a microcontroller unit disposed between the detection unit and the interface unit, and configured to perform post processing on signals provided from the detection unit, and control transmission and reception of data to and from the electronic device via the interface unit.

8. The textile interface device of claim 1, wherein the electronic device comprises application software that records and analyzes data about the optical signals received from the interface unit.

9. The textile interface device of claim 1, wherein:
the electronic device comprises an optical transmission and reception connector connected to an external extension port of the electronic device to perform optical communication with the interface unit; and
the optical transmission and reception connector comprises:
a connection port connected to the external extension port of the electronic device;
a transmission unit configured to send the optical signals transferred from the electronic device;
a reception unit configured to receive the optical signals from the interface unit; and
a control unit configured to convert the optical signals sent and received between the electronic device and the interface unit, and to perform buffering in order to convert the optical signals.

10. The textile interface device of claim 1, wherein the wearing means further comprises an external interface unit that connects with an external debugger and performs charging.

11. The textile interface device of claim 1, wherein the accommodation means comprises:
an accommodation space configured to accommodate the electronic device in an inner space thereof; and
an opening formed in a region of the accommodation means corresponding to the screen of the accommodated electronic device so that the screen of the accommodated electronic device can be exposed to an outside.

12. A textile interface method for use with a human body-worn band, comprising:
detecting a wearer's bio-signals using a detection unit provided in wearing means;
receiving the bio-signals and control signals generated by textile buttons via a textile-formed interface unit inside accommodation means provided on one side of the wearing means; and
performing optical communication with an electronic device accommodated in the accommodation means via the interface unit;
wherein the performing optical communication comprises:
once the electronic device has been inserted into the accommodation space, completing a connection for the optical communication via the interface unit;
sending the bio-signals and the control signals generated by the textile buttons to the electronic device via the interface unit;
recording and analyzing data about the bio-signals using application software of the electronic device; and
controlling the electronic device based on the control signals generated by the textile buttons using the application software of the electronic device.

13. The textile interface method of claim 12, wherein the receiving the bio-signals and control signals generated by textile buttons comprises removing noise from the bio-signals, amplifying the bio-signals from which the noise has been removed, and digitizing the amplified bio-signals using a preprocessing unit of the detection unit.

14. The textile interface method of claim 12, wherein the performing optical communication comprises performing, by the electronic device, optical communication with the interface unit via an optical transmission and reception connector connected to an external extension port.
